(19) United States
(12) Patent Application Publication
(10) Pub. No.: US 2026/0368008 A1
(43) Pub. Date: Nov. 19, 2026

(54) SYSTEM AND METHOD OF USING ARTIFICIAL INTELLIGENCE TO MANAGE MESSAGE TRAFFIC AMONG INFORMATION HANDLING SYSTEMS

(71) Applicant: DELL PRODUCTS L.P., Round Rock, TX (US)

(72) Inventors: Avinash Kumar, Patna (IN); Nitesh Pandey, Bangalore (IN); Parminder Singh Sethi, Ludhiana (IN)

(21) Appl. No.: 19/210,934

(22) Filed: May 16, 2025

(51) Int. Cl. G06F 9/54; H04L 47/11

(52) U.S. Cl. CPC G06F 9/546; H04L 47/11; G06F 2209/548

(57) ABSTRACT

A message delivery system for a plurality of information handling systems is disclosed and includes at least one information handling system that includes a computer readable medium including an artificial intelligence (AI) adaptive message throttling model. The computer readable medium further includes a processor operably coupled to the computer readable medium to access the AI adaptive message throttling model to monitor real-time message queue congestion, monitor real-time system resource usage, determine when a message queue congestion approaches a predetermined threshold, and dynamically adjust message processing rates, when the message queue congestion approaches the predetermined threshold.

### FIELD OF THE DISCLOSURE

The present disclosure generally relates to information handling systems, and more particularly relates to managing message traffic in a message delivery system having multiple information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A message delivery system includes at least one information handling system having an artificial intelligence (AI) adaptive message throttling model. A processor accesses the AI adaptive message throttling model to monitor real-time message queue congestion, monitor real-time system resource usage, determine when a message queue congestion approaches a predetermined threshold, and dynamically adjust message processing rates, when the message queue congestion approaches the predetermined threshold.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a message delivery system having a series of interconnected information handling systems according to an embodiment of the present disclosure;

FIG. 2 is a block diagram of an information handling system according to an embodiment of the present disclosure;

FIG. 3 is a flow diagram of a method of using artificial intelligence to provide adaptive message throttling in a message delivery system having interconnected information handling systems according to an embodiment of the present disclosure; and

FIG. 4 is a block diagram of still another information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

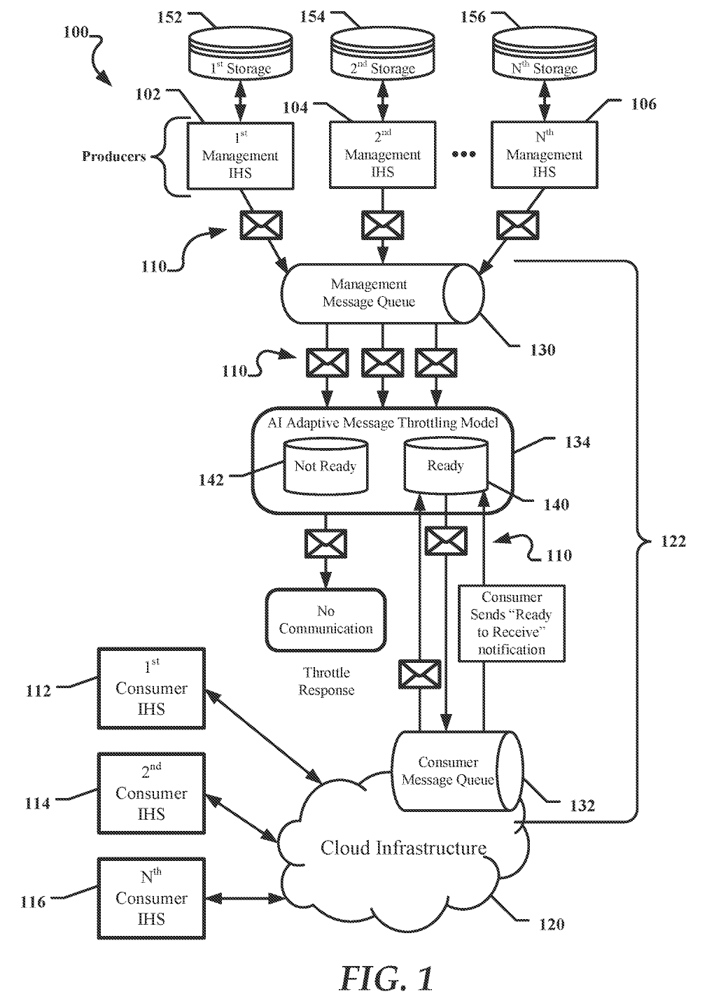

Referring initially to FIG. 1, a message delivery system is shown and is generally designated 100. As shown, the message delivery system 100 may include a first management information handling system 102, a second management information handling system 104, and an Nth management information handling system 106. Each information handling system 102, 104, 106 may exchange messages 110 with one or more of a first consumer information handling system 112, a second consumer information handling system 114, and an Nth consumer information handling system 116 via a cloud infrastructure 120 and a message queue system 122.

The message queue system 122 includes a management message queue 130 that is operably coupled to each of the first management information handling system 102, the second management information handling system 104, and the Nth management information handling system 106. Further, the management message queue 130 is also operably coupled to a consumer message queue 132 via an AI adaptive message throttling model 134. The consumer message queue 132 is operably coupled to each of the first consumer information handling system 112, the second consumer information handling system 114, and the Nth consumer information handling system 116. As shown, the AI adaptive message throttling model 134 includes a ready queue 140 and a not ready queue 142. During operation of the message delivery system 100 some messages 100 may be throttled by the AI adaptive message throttling model 134, and placed in the not ready queue, to prevent delivery of those messages. Conversely, other messages 100 may be placed in the ready queue 140 by the AI adaptive message throttling model 134 and may be allowed to be delivered.

As shown, the first management information handling system 102 may be operably coupled to a first storage database 152. The second management information handling system 104 may be operably coupled to a second storage database 150. Further, the Nth management information handling system 106 may be operably coupled to an Nth storage database 156. While transmitting and receiving messages the management information handling systems 102, 104, 106 may access respective storage databases 152, 154, 156 as needed.

In a particular aspect, during operation, the AI adaptive message throttling model 134 may utilize reinforcement learning to dynamically manage message queue congestion and prioritize tasks. The AI adaptive message throttling model 134 continuously learns from real-time data on queue congestion and resource utilization to adapting a message queue management policy in order to continuously optimize performance. The AI adaptive message throttling model 134 may assign priority levels to producers based on historical performance, data criticality, and current workload dynamics. When the message queue approaches congestion thresholds, the AI adaptive message throttling model 134 may adjust message processing rates and prioritize critical tasks. Moreover, the AI adaptive message throttling model 134 may instruct less critical producers to temporarily halt (that is, "snooze") their message influx to ensure balanced resource allocation and consistent system performance.

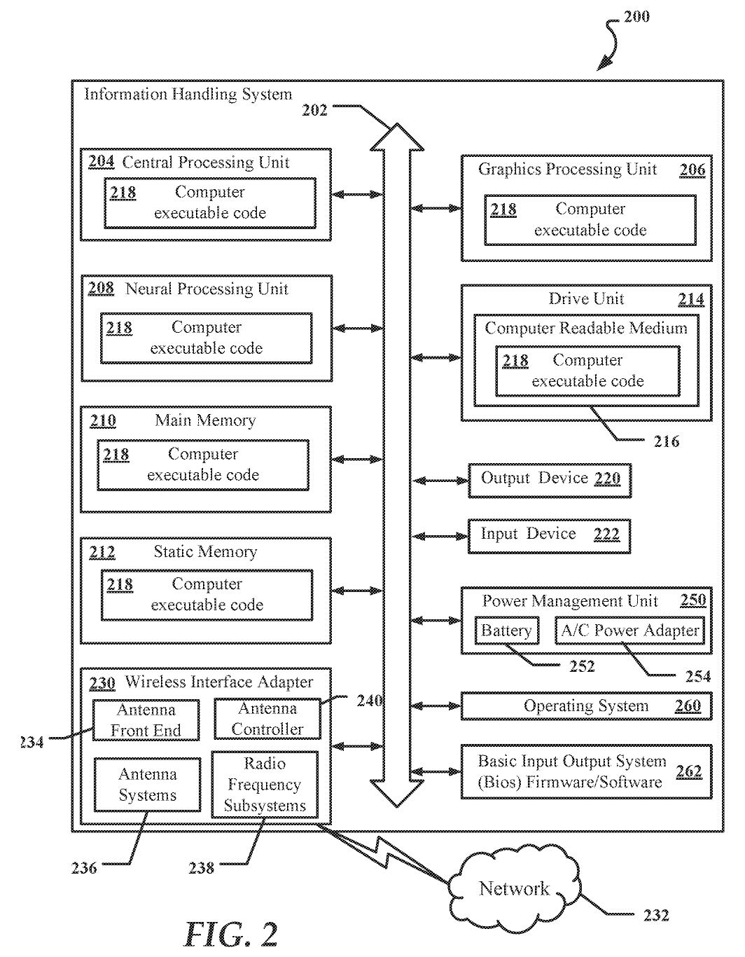

FIG. 2 illustrates an information handling system 200 having various components disposed therein. For purposes of this disclosure, the information handling system 200 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 200 can be a personal computer, a mobile device (for example, a personal digital assistant (PDA) or a smart phone), server (for example, a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (for example, a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 200 may operate in the capacity of a server or as a client computer in a server-client network environment, or as a peer computer system in a peer-to-peer (or distributed) network environment. In a particular embodiment, the information handling system 200 can be implemented using electronic information handling systems that provide voice, video or data communication. For example, an information handling system 200 may be any mobile or other computing device capable of executing a set of instructions (sequential or otherwise) that specify actions to be taken by that machine. Further, while a single information handling system 200 is illustrated, the term “system” shall also be taken to include any collection of systems or sub-systems that individually or jointly execute a set, or multiple sets, of instructions to perform one or more computer functions.

In general, the information handling system 200 can include memory (volatile (for example, random-access memory, etc.), nonvolatile (read-only memory, flash memory etc.) or any combination thereof), one or more processing resources, such as a central processing unit (CPU), a graphics processing unit (GPU), a neural processing unit (NPU), hardware or software control logic, or any combination thereof. Additional components of the information handling system 200 can include one or more storage devices, one or more communications ports for communicating with external devices, as well as, various input and output (I/O) devices, such as a keyboard, a mouse, a video/graphic display, or any combination thereof. The information handling system 200 can also include one or more buses operable to transmit communications between the various hardware components. Portions of an information handling system 200 may themselves be considered information handling systems 200. The information handling system 200 can include devices or modules that embody one or more of the devices or execute instructions for the one or more systems and modules described herein, and operates to perform one or more of the methods described herein.

As illustrated in FIG. 2, in particular, the information handling system 200 can include one or more buses 202 operable to transmit communications between the various hardware components such as any combination of various input and output (I/O) devices described herein. The information handling system 200 can include one or more processors operably coupled to the bus 202. For example, the information handling system 200 can include a central processing unit (CPU) 204, a graphics processing unit (GPU) 206, a neural processing unit (NPU) 208, or any combination thereof. The CPU 204, the GPU 206, and the NPU 208 may include control logic and may individually, or collectively, operate to execute code that is either firmware or software code. Moreover, the information handling system 200 can include one or more memory devices such as a main memory 210, a static memory 212, and a drive unit 214 having a computer readable medium 216 disposed therein. The drive unit 214 can include a hard drive unit, a solid state drive unit, or a combination thereof. Further, the various memory devices 210, 212, 214, 216 may include volatile memory (for example, random-access memory, etc.), nonvolatile memory (read-only memory, flash memory etc.) or any combination thereof).

The information handling system 200 includes computer executable code 218 that may reside on, or be executed by, the CPU 204, the GPU 206, the NPU 208, the main memory 210, the static memory 212, the computer readable medium 216 of the drive unit 214, or any combination thereof. The computer executable code 218 can include instructions (for example, software algorithms), parameters, and profiles. The computer executable code 218 that may operate on servers or systems, remote data centers, or on-box in individual client information handling systems according to various embodiments herein. In some embodiments, it is understood any or all portions of the computer executable code 218 may operate on, or be executed by, the CPU 204, the GPU 206, the NPU 208, the main memory 210, the static memory 212, the computer readable medium 216 of the drive unit 214, or any combination thereof. In some embodiments, it is understood any or all portions of computer executable code 218 may operate on a plurality of information handling systems 200.

As shown, the information handling system 200 may further include an output device 220 such as a video display output. In an embodiment, the output device 220 may include a liquid crystal display (LCD), an organic light emitting diode (OLED), a flat panel display, a solid-state display, a curved panel display, a flexible panel display, or a combination thereof. Further, the output device 220 may include one or more sound output devices such as speakers. As further illustrated, the information handling system 200 may include an input device 222 that may include an alpha numeric input device, such as a keyboard, and/or a cursor control device, such as a mouse, touchpad, or gesture or touch screen input device.

The information handling system 200 may also include a network interface device, shown as a wireless interface adapter 230, that can provide connectivity to a network 232 such as a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 200 to a network. In a specific embodiment, the network 254 may include macro-cellular connections via one or more base stations, one or more wireless access points (for example Wi-Fi or WiGig), one or more licensed or unlicensed WWAN small cell base stations, or a combination thereof. Further, network connectivity may be a wired or wireless connection.

As depicted, the wireless interface adapter 230 may include an antenna front end 234, one or more antenna systems 236, one or more radio frequency subsystems 238, and an antenna controller 240. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 234 may communicate with one or more wireless technology protocols. The radio frequency subsystem 234 may contain individual subscriber identity module (SIM) profiles for each technology service provider and their available protocols for any operating subscriber-based radio access technologies such as cellular LTE communications.

In some embodiments of the present disclosure, the wireless interface adapter 230 may operate two or more wireless links. In a further embodiment, the wireless interface adapter 230 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 230 may operate in accordance with any wireless data communication standards. To communicate with a wireless local area network, standards including IEEE 802.11 WLAN standards (for example IEEE 802.11ax-2021 (Wi-Fi 6E, 6 GHz)), IEEE 802.15 WPAN standards, WWAN such as 3GPP or 3GPP2, or similar wireless standards may be used. Wireless interface adapter 230 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5MHz frequency band such as 802.11 a/h/j/n/ac/ax (for example center frequencies between 5.170-7.125 GHz). WLAN, for example, may operate at a 2.4 GHz band, 5GHz band, and/or a 6 GHz band according to, for example, Wi-Fi, Wi-Fi 6, or Wi-Fi 6E standards. WWAN may operate in a number of bands, some of which are proprietary but may include a wireless communication frequency band.

For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 2 (NRFR1), NFRF2, bands, and other known bands. Each of these frequencies used to communicate over the network 254 may be based on the radio access network (RAN) standards that implement, for example, eNodeB or gNodeB hardware connected to mobile phone networks (such as, cellular networks) used to communicate with the information handling system 200. In the example embodiment, mobile device 200 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 200 may operate on a licensed WWAN wireless radio with authorization for subscriber access to a wireless service provider on a carrier licensed frequency band.

The wireless interface adapter 230 can represent an add-in card, wireless network interface module that is integrated with a main board of the information handling system or integrated with another wireless network interface capability, or any combination thereof. In an embodiment the wireless interface adapter 230 may include one or more radio frequency subsystems 230 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 230 include wireless controllers to manage authentication, connectivity, communications, power levels for transmission, buffering, error correction, baseband processing, and other functions of the wireless interface adapter 230.

The information handling system 200 may further include a power management unit (PMU) 250 (a.k.a. a power supply unit (PSU)). The PMU 250 may manage the power provided to the components of the information handling system 200, such as, the CPU 204, the GPU 206, the NPU 208, the main memory 210, the static memory 212, the drive unit 214, the output device 220, the input device 222, the wireless interface adapter 230, any combination thereof, and any other components that may require power when a power button on the information handling system 200 is actuated by a user. In an embodiment, the PMU 250 may monitor power levels and be electrically coupled to the information handling system 200 to provide this power and coupled to bus 208 to provide or receive data or instructions. The PMU 250 may regulate power from a power source such as a battery 252 or A/C power adapter 254. In an embodiment, the battery 252 may be charged via the A/C power adapter 254 and provide power to the components of the information handling system 200 when A/C power from the A/C power adapter 254 is removed.

FIG. 2 further indicates that the information handling system 200 includes an operating system (OS) 260, a basic input/output system (BIOS) firmware/software 262, one or more application programs, or a combination thereof that may be part of the computer executable code 218 that is executed at the CPU 204, the GPU 206, the NPU 208, or a combination thereof, and stored the main memory 210, the static memory 212, the computer readable medium 216 of the drive unit 214, or any combination thereof. The BIOS firmware/software 262 functions to initialize information handling system 200 on power up, to launch the OS 260, and to manage input and output interactions between the OS 260 and the other elements of information handling system 200. In a particular embodiment, BIOS firmware/software 262 resides in the main memory 208 or the static memory 212, and includes machine-executable code that is executed by the CPU 204 to perform various functions of information handling system 200 as described herein. In another embodiment (not illustrated), application programs and BIOS firmware/software 262 can reside in another storage medium of information handling system 200. For example, application programs and BIOS firmware/software 262 can reside in the drive unit 214, in a ROM (not illustrated) associated with information handling system 200, in an option-ROM (not illustrated) associated with various devices of information handling system 200, in a storage system (not illustrated) associated with network channel of the wireless interface adapter 230, in another storage medium of information handling system 200, or a combination thereof. It is to be understood that computer executable code 218 for application programs and BIOS firmware/software 238 can each be implemented as single programs, or as separate programs carrying out the various features as described herein.

As stated above, the information handling system 200 may connect to the external wireless network 232. In particular, the wireless network 232 may have a wireless mesh architecture in accordance with mesh networks described by the wireless data communications standards or similar standards in some embodiments but not necessarily in all embodiments. The wireless interface adapter 230 may connect to the external wireless network 233 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 216 that includes computer executable code 218 (such as, instructions, parameters, and profiles), or receives and executes computer executable code 218 (such as, instructions, parameters, and profiles) responsive to a propagated signal; so that a device connected to the wireless network 232 can communicate voice, video or data over the wireless network 232. Further, the computer executable code 218 may be transmitted or received over the wireless network 232 via the network interface device, that is, the wireless interface adapter 230.

The wireless interface adapter 230 represents a network interface card (NIC) disposed within information handling system 200, on a main circuit board of the information handling system 200, integrated onto another component such as the CPU 204, in another suitable location, or a combination thereof. The wireless interface adapter 230 can include another information handling system, a data storage system, another network, a grid management system, another suitable resource, or a combination thereof. In an embodiment, the wireless interface adapter 230 may operably connect to the network 232. The connection to network 232 may be wired or wireless.

The network interface device shown as wireless interface adapter 230 can provide connectivity to the network 232, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 230 may include an adaptive massive MIMO Multiplexer with transmitter/receiver circuitry, wireless controller circuitry, amplifiers and other circuitry for wireless communications. The wireless interface adapter 230 may also include antenna systems 236 as described above which may be tunable antenna systems for use with the system and methods disclosed in the embodiments herein. The antenna controller 240 may also include wireless controllers to manage authentication, connectivity, communications, power levels for transmission, buffering, error correction, baseband processing, and other functions of the wireless interface adapter 230.

The information handling system 200 can include a set of computer executable code 218 that can be executed to cause the information handling system 200 to perform any one or more of the methods or computer-based functions disclosed herein. For example, computer executable code 218 may execute various software applications, software agents, or other aspects or components. Various software modules comprising application computer executable code 218 may be coordinated by the OS 260, and/or via an application programming interface (API). An example operating system may include Windows ®, Android ®, and other OS types known in the art. Example APIs may include Win 32, Core Java API, or Android APIs.

The drive unit 214 may include a computer-readable medium 216 in which one or more sets of computer executable code 218 such as software can be embedded to be executed by the CPU 204, the GPU 206, the NPU 208, or a combination thereof, to perform the processes described herein. Similarly, main memory 204 and static memory 206 may also contain a computer-readable medium for storage of one or more sets computer executable code 218 (such as, instructions, parameters, or profiles). The drive unit 214 or static memory 212 also contain space for data storage. Further, the computer executable code 218 may embody one or more of the methods or logic as described herein. In a particular embodiment, the computer executable code 218 may reside completely, or at least partially, within the main memory 204, the static memory 206, and/or within the disk drive 216 during execution by the CPU 204 of the information handling system 200. The CPU 204, the GPU 206, and the NPU 208 also may include computer-readable media. The NPU 208 may include computer executable code 218 that includes an artificial intelligence (AI) adaptive message throttling model provides adaptive message throttling, as described in greater detail elsewhere herein, to ensure efficient delivery of messages, while minimizing congestion in message queues, between interconnected information handling systems.

The main memory 208, the static memory 212, or other memory of the embodiments described herein may contain computer-readable medium (not shown), such as RAM. An example of main memory 208 can include random access memory (RAM) such as static RAM (SRAM), dynamic RAM (DRAM), non-volatile RAM (NV-RAM), or the like, read only memory (ROM), another type of memory, or a combination thereof. The static memory 212 may contain computer-readable medium (not shown), such as NOR or NAND flash memory in some example embodiments. The drive unit 214 may include access to a computer-readable medium 216 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

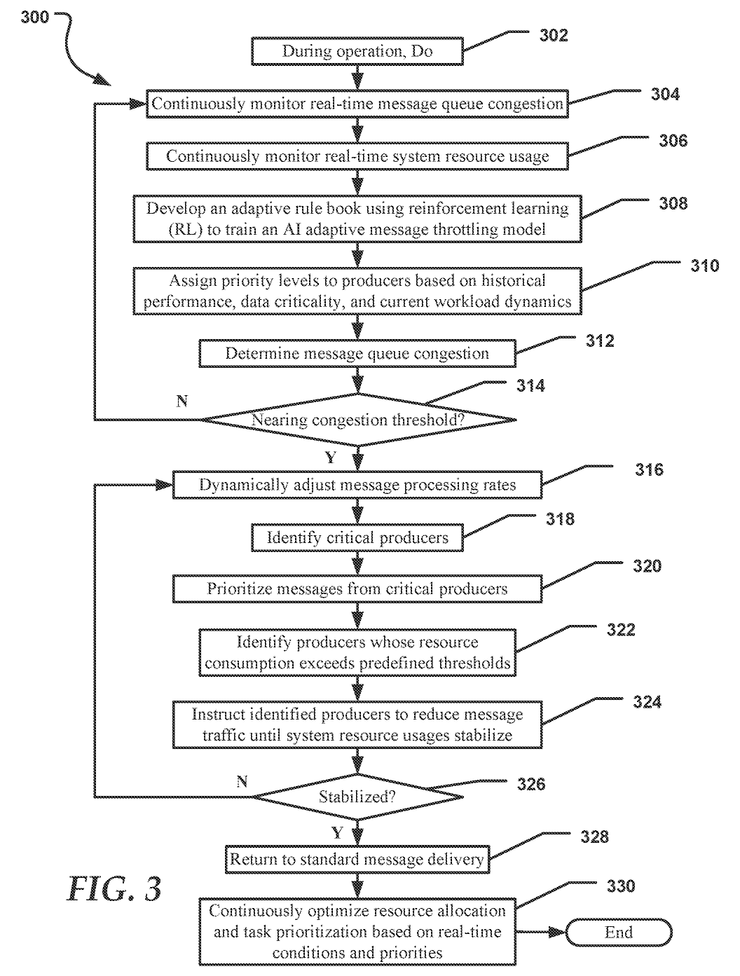

FIG. 3 illustrates a flow diagram of a method 300 of using artificial intelligence to provide adaptive message throttling in a message delivery system between a plurality of interconnected information handling systems. The method 300 may be performed, for example, in an information handling system that is configured according to at least one embodiment of an information handling system that is described in the present disclosure and the method 300 commences at block 302. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIG. 3 may be executed, or employed in whole, or in part, by any of the processors disclosed herein, any other type of controller, device, module, processor, or any combination thereof, operable to employ, or otherwise execute, all, or portions of, the method 300 of FIG. 3.

Beginning at block 302, the method 300 includes entering a do loop wherein during operation of a message delivery system having multiple interconnected information handling systems, the following steps are performed. At block 304, the method 300 may include continuously monitoring real-time message queue congestion. The real-time queue congestion metrics may include real-time data representing the current state of the message queue, such as the number of messages, processing times, and congestion levels. At block 306, the method 300 may include continuously monitoring real-time system resource usages. The resource usages may include real-time CPU usage, RAM utilization, disk I/O, and network throughput in order to determine the system load.

Moving to block 308, the method 300 ma include develop an adaptive rule book using reinforcement learning (RL) to train an AI adaptive message throttling model. In particular, the AI adaptive message throttling model may be trained using the following steps: state representation, action space, reward function, and simulated model training. The state representation includes, for example, defining the state of the system using collected data, such as current queue length, system resource utilization, and producer priority levels. The action space may include the possible actions that the AI adaptive message throttling model may execute and may include, for example, including adjusting message processing rates, assigning priorities to producers, and instructing producers to "snooze." The reward function may include the incentives to the AI adaptive message throttling model to minimize queue congestion, optimize resource utilization, and prioritize critical tasks. Rewards may be based on factors like reduced latency, balanced resource load, and successful processing of high-priority messages. Finally, simulated model training includes training the AI adaptive message throttling model using historical data and simulated environments to learn optimal policies. Further, the AI adaptive message throttling model may continuously update the management policy based on real-time data and feedback. It is to be understood that each producer may be a management information handling system that is receiving messages and responding to messages (that is, sending messages).

Proceeding to block 310, the method 300 may include assigning priority levels to producers based on historical performance, data criticality, and current workload dynamics. For example, the historical performance may include past message processing times, success rates, and error frequencies of producers. Additionally, the data criticality scores may include an assessment (and numerical score) that indicates the importance of data being processed by each producer based on predefined criteria such as business impact and SLA requirements. The data criticality score may be a number between one and five with a higher score indicating greater criticality of the data. Finally, the workload dynamics may include observing patterns in workload behavior, including peak periods, typical message sizes, and frequency of message submissions. The current workload dynamics may be compared to the previously observed patterns.

Moving to block 312, the method 300 may include determining the current message queue congestion. Thereafter, at decision 314, the method 300 may include determine whether the current message queue congestion is nearing a predetermined congestion threshold. If the current message queue congestion is not nearing the predetermined congestion threshold, the method 300 may return to block 304 and continue as described herein. On the hand, at decision 314, if the current message queue congestion is nearing the predetermined congestion threshold, the method 300 may proceed to block 316. At block 316, the method 300 may include dynamically adjust message processing rates. Further, at block 318, the method 300 may include identifying at least one critical producer. Then, at block 320, the method 300 may include prioritizing messages from the critical producers. At block 322, the method 300 may include identifying overconsuming producers whose resource consumption exceeds predefined thresholds. At block 324, the method 300 may include instructing the identified overconsuming producers to reduce message traffic (delivery/influx) until system resource usages stabilize.

Continuing to decision 326, the method 300 may determine whether the system resource usages have stabilized. If not, the method 300 may return to block 316 and continue as described herein. On the other hand at decision 324, when the method 300 determines that the system resource usages have stabilized, the method 300 may proceed to block 328 and the method 300 may include returning to standard message delivery. Then, at block 330, the method 300 may include continuously optimizing resource allocation and task prioritization based on real-time conditions and priorities. Then, the method 300 may end.

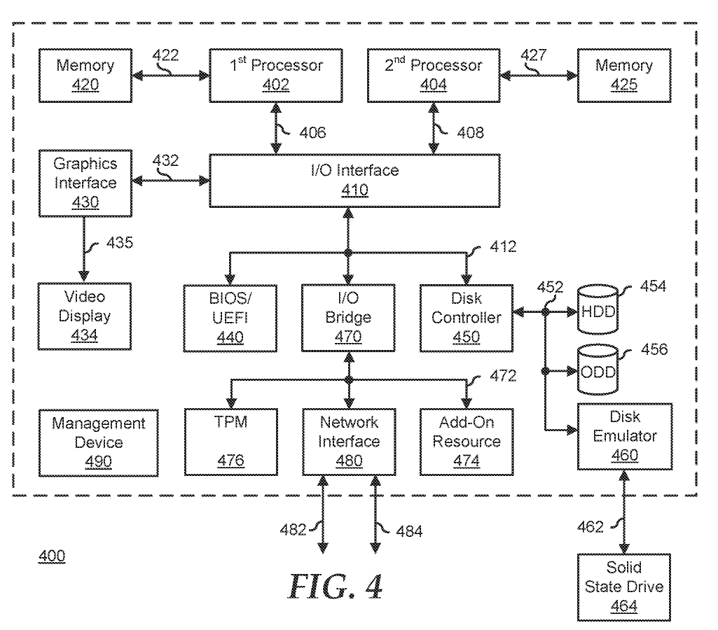

FIG. 4 shows a generalized embodiment of an information handling system 400 according to an embodiment of the present disclosure. Information handling system 400 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described herein. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456 , a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

The systems and methods described herein utilize an artificial intelligence (AI) adaptive throttling model to continuously monitor real-time message queue congestion and resource utilization. Further, the systems and methods herein provide an adaptive rule book using reinforcement learning algorithms to assign priority levels to producers by considering factors such as historical performance, data criticality, and current workload dynamics. As the message queue nears congestion thresholds, the systems and methods disclosed herein may dynamically adjust message processing rates and prioritize tasks from critical producers identified by the RL model. For example, producers which are exceeding predefined thresholds will be temporarily instructed to “snooze" in order to reduce message influx until system resources stabilize. Accordingly, resource allocation may be optimized while critical tasks are effectively prioritized. Further, consistent performed may be maintained during various workload conditions.

In another particular aspect, the AI adaptive message throttling model may be trained through the use of reinforcement learning that utilizes selected system data in order to provide adaptive throttling and producer prioritization. The system data may include historical performance data, real-time queue congestion metrics, resource utilization metrics, data criticality scores, workload dynamics, or any combination thereof. For example, the historical performance may include past message processing times, success rates, and error frequencies of producers. The real-time queue congestion metrics may include real-time data representing the current state of the message queue, such as the number of messages, processing times, and congestion levels. Further, the resource utilization metrics may include real-time CPU usage, RAM utilization, disk I/O, and network throughput in order to determine the system load. Additionally, the data criticality scores may include an assessment (and numerical score) that indicates the importance of data being processed by each producer based on predefined criteria such as business impact and SLA requirements. The data criticality score may be a number between one and five with a higher score indicating greater criticality of the data. Finally, the workload dynamics may include observing patterns in workload behavior, including peak periods, typical message sizes, and frequency of message submissions.

The systems and methods disclosed herein utilize reinforcement learning to train the AI adaptive message throttling model to dynamically manage message queue congestion and prioritize tasks. In particular, the AI adaptive message throttling model may be trained using the following steps: state representation, action space, reward function, and simulated model training. For the first state representation step, the AI adaptive message throttling model may define the state of the system using collected data, such as current queue length, system resource utilization, and producer priority levels. For the second action space step, the possible actions that the AI adaptive message throttling model may execute are defined and may include, for example, including adjusting message processing rates, assigning priorities to producers, and instructing producers to "snooze." For the third reward function step, a reward function may be designed, or otherwise created, that incentivizes the AI adaptive message throttling model to minimize queue congestion, optimize resource utilization, and prioritize critical tasks. Rewards may be based on factors like reduced latency, balanced resource load, and successful processing of high-priority messages. Finally, for the fourth simulated model training step, the AI adaptive message throttling model may be trained using historical data and simulated environments to learn optimal policies. Additionally, the AI adaptive message throttling model may continuously update the management policy based on real-time data and feedback.

In one particular aspect, the systems and methods disclosed use dynamic and adaptive message queue management and producer prioritization, to leverage reinforcement learning of an AI adaptive message throttling model in order to optimize resource utilization while ensuring strong security by mitigating potential overloads that could expose vulnerabilities. The dynamic nature of the systems and methods disclosed herein obviate the need for static resource allocation strategies that fail to adapt to changing workloads and lead to inefficiencies and potential security vulnerabilities. By optimizing resource utilization and dynamically managing workloads, the systems and methods disclosed herein may reduce operational costs while maintaining high service performance, ultimately leading to better resource allocation and increased return of investment. Further, prioritizing tasks and managing message queue congestion in real-time allows organizations to mitigate security threats effectively, reducing the risk of breaches and ensuring compliance with security standards, which enhances overall business trust and reputation.

### Operational Example

During a major software product launch, a cloud-based customer support platform may experience a sudden surge in support tickets and communication requests. The message queue for the customer support platform may very quickly become congested as various support teams (that is, producers) submit high-priority tickets, routine inquiries, and system updates. Using the systems and methods disclosed herein, the AI adaptive message throttling model is able to optimize resource utilization and prevent system overload in this scenario. The AI adaptive message throttling model continuously monitors the real-time queue congestion and resource utilization, learning from past data on ticket priorities and system load. As the message queue approaches congestion thresholds, the AI adaptive message throttling model may dynamically adjust processing rates and prioritize tasks from critical support teams handling urgent issues.

For instance, tickets flagged as "urgent" or related to critical system bugs may be processed immediately. Less critical updates or routine inquiries from other support teams may be temporarily "snoozed." This dynamic prioritization ensures that resources are allocated efficiently, critical tasks are handled promptly, and the overall system performance remains stable, even during peak load periods.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A message delivery system for a plurality of information handling systems, the message delivery system comprising:
at least one information handling system having:
a computer readable medium including an artificial intelligence (AI) adaptive
message throttling model; and
a processor operably coupled to the computer readable medium to access the AI
adaptive message throttling model to:
monitor real-time message queue congestion;
monitor real-time system resource usage;
determine when a message queue congestion approaches a predetermined
threshold; and
dynamically adjust message processing rates, when the message queue
congestion approaches the predetermined threshold.

1. The information handling system of claim 1, wherein the processor further accesses the AI adaptive message throttling model to:
identify at least one critical information handling system.

2. The information handling system of claim 2, wherein the processor further accesses the AI adaptive message throttling model to:
prioritize messages from the at least one critical information handling system.

3. The information handling system of claim 3, wherein the processor further accesses the AI adaptive message throttling model to:
identify at least one overconsuming information handling system.

4. The information handling system of claim 4, wherein the processor further accesses the AI adaptive message throttling model to:
instruct the at least one overconsuming information handling system to reduce message traffic.

5. The information handling system of claim 5, wherein the processor further accesses the AI adaptive message throttling model to:
determine when system resource usages stabilize.

6. The information handling system of claim 6, wherein the processor further accesses the AI adaptive message throttling model to:
return to standard message delivery when system resource usages stabilize.

7. The information handling system of claim 7, wherein the processor further accesses the AI adaptive message throttling model to:
assign priority levels to one or more of the plurality of information handling systems based on historical performance, data criticality, current workload dynamics, or a combination thereof.

8. A method of throttling message traffic in a message delivery system using an artificial intelligence (AI) adaptive message throttling model, the method including:
monitoring real-time message queue congestion;
monitoring real-time system resource usage;
determining when message queue congestion approaches a predetermined
threshold; and
dynamically adjusting message processing rates, when message queue congestion
approaches the predetermined threshold.

9. The method of claim 9, further comprising:
identifying at least one critical information handling system.

10. The method of claim 10, further comprising:
prioritizing messages from the at least one critical information handling system.

11. The method of claim 11, further comprising:
identify at least one overconsuming information handling system.

12. The method of claim 12, further comprising:
instructing the at least one overconsuming information handling system to reduce message traffic.

13. The method of claim 13, further comprising:
determining when system resource usages stabilize.

14. The method of claim 14, further comprising:
returning to standard message delivery when system resource usages stabilize.

15. The method of claim 15, further comprising:
assign priority levels to one or more of a plurality of information handling systems based on historical performance, data criticality, current workload dynamics, or a combination thereof.

16. An information handling system having:
a computer readable medium including an artificial intelligence (AI) adaptive
message throttling model; and
a processor operably coupled to the computer readable medium to access the AI
adaptive message throttling model to:
monitor real-time message queue congestion in a message delivery system;
monitor real-time system resource usage in the message delivery system;
determine when a message queue congestion approaches a predetermined
threshold; and
dynamically adjust message processing rates, when the message queue congestion
approaches the predetermined threshold.

17. The information handling system of claim 17, wherein the processor further accesses the AI adaptive message throttling model to:
identify at least one critical information handling system in the message delivery system; and
prioritize messages from the at least one critical information handling system.

18. The information handling system of claim 18, wherein the processor further accesses the AI adaptive message throttling model to:
identify at least one overconsuming information handling system in the message delivery system; and
instruct the at least one overconsuming information handling system to reduce message traffic.

19. The information handling system of claim 19, wherein the processor further accesses the AI adaptive message throttling model to:
determine when system resource usages stabilize in the message delivery system; and
return to standard message delivery when system resource usages stabilize.
